(19) United States
(12) Patent Application Publication
(10) Pub. No.: US 2026/0112368 A1
(43) Pub. Date: Apr. 23, 2026

(54) ELECTRONIC DEVICES AND METHODS OF PROCESSING USER UTTERANCES

(71) Applicant: SAMSUNG ELECTRONICS CO., LTD., Suwon-si (KR)

(72) Inventors: Sangmin PARK, Suwon-si (KR); Gajin SONG, Suwon-si (KR); Kyungtae KIM, Suwon-si (KR)

(73) Assignee: SAMSUNG ELECTRONICS CO., LTD., Suwon-si (KR)

(21) Appl. No.: 19/427,027

(22) Filed: Dec. 19, 2025

Related U.S. Application Data
(63) Continuation of application No. PCT/KR2024/008110, filed on Jun. 13, 2024.

(30) Foreign Application Priority Data
Jun. 22, 2023 (KR) 10-2023-0080093
Aug. 9, 2023 (KR) 10-2023-0104117

(51) Int. Cl. G10L 15/22; G06F 16/951

(52) U.S. Cl. CPC G10L 15/22; G06F 16/951; G10L 2015/223

(57) ABSTRACT

An electronic device including at least one wireless communication circuit configured to transmit and receive a wireless signal to and from a nearby device positioned around the electronic device; at least one processor operatively connected to the at least one wireless communication circuit; and memory storing instructions. The instructions, when executed by the at least one processor individually or collectively, cause the electronic device to: receive, from a user, an utterance for controlling the electronic device or the nearby device; based on an analysis result of the utterance, obtain information utilized for machine reading comprehension; obtain additional information related to the utterance by performing the machine reading comprehension based on the information; and based on the additional information, provide the user with a response corresponding to the utterance.

### CROSS-REFERENCE TO RELATED APPLICATIONS

This application is a bypass continuation application of International Application No. PCT/KR2024/008110, filed on Jun. 13, 2024, which claims priority to Korean Patent Application No. 10-2023-0080093, filed on Jun. 22, 2023, and Korean Patent Application No. 10-2023-0104117, filed on Aug. 9, 2023, in the Korean Intellectual Property Office, the disclosures of which are incorporated by reference herein in their entireties.

### BACKGROUND

### 1. Field

Embodiments of the present disclosure relate to an electronic device and a method of processing a user utterance.

### 2. Description of Related Art

Electronic devices equipped with voice assistant functions that provide services based on user utterances are becoming increasingly widespread. An electronic device may recognize a user utterance through an artificial intelligence (AI) server and understand the meaning and intent of the user utterance. The AI server may interpret the user utterance to infer the intent of the user and may perform tasks according to the inferred intent. Through natural language interactions between the user and the AI server, the server may perform tasks based on the expressed intent of the user.

An electronic device equipped with a voice assistant function may sequentially perform an operation of classifying domains for processing user utterances and an operation of performing a task corresponding to a user utterance in a classified domain (e.g., a capsule) (e.g., an application).

The above information may be presented as the related art to help with the understanding of the disclosure. No arguments or decisions are raised to whether any of the above description is applicable as the prior art related to the present disclosure.

### SUMMARY

According to an aspect of the disclosure, an electronic device including at least one wireless communication circuit configured to transmit and receive a wireless signal to and from a nearby device positioned around the electronic device; at least one processor operatively connected to the at least one wireless communication circuit; and memory storing instructions. The instructions, when executed by the at least one processor individually or collectively, cause the electronic device to: receive, from a user, an utterance for controlling the electronic device or the nearby device; based on an analysis result of the utterance, obtain information utilized for machine reading comprehension; obtain additional information related to the utterance by performing the machine reading comprehension based on the information; and based on the additional information, provide the user with a response corresponding to the utterance.

The information utilized for the machine reading comprehension is obtained when the utterance includes at least one of: an unsupported control command; an unsupported parameter value; and a parameter preset to provide the additional information.

The information utilized for the machine reading comprehension includes at least one of information about the electronic device, information about the nearby device, a query for crawling data, crawled data, or a question for obtaining a machine reading comprehension result.

The instructions, when executed by the at least one processor individually or collectively, cause the electronic device to: based on the analysis result of the utterance, obtain the information on the electronic device or the information on the nearby device; based on the information on the electronic device or the information on the nearby device, generate a query for crawling data; crawl data based on the query; and generate a question for performing the machine reading comprehension on the crawled data.

The additional information is obtained by performing the machine reading comprehension on the crawled data based on the question.

The additional information includes information related to a control action included in the utterance.

According to the utterance, the additional information includes a reason for which the electronic device or the nearby device is unable to be controlled.

The additional information includes guidance for correcting a control action included in the utterance.

According to an aspect of the disclosure, an electronic device including at least one wireless communication circuit configured to transmit and receive a wireless signal to and from a nearby device positioned around the electronic device; at least one processor operatively connected to the at least one wireless communication circuit; and memory storing instructions,

The instructions, when executed by the at least one processor individually or collectively, cause the electronic device to: receive, from a user, an utterance for controlling the electronic device or the nearby device; based on an analysis result of the utterance, generate a question; and based on the question, provide the user with a response including additional information related to the utterance. The question is utilized for machine reading comprehension.

The question is generated when the utterance includes at least one of: an unsupported control command; an unsupported parameter value; and a parameter preset to provide the additional information.

The instructions, when executed by the at least one processor individually or collectively, cause the electronic device to: based on the analysis result of the utterance, obtain information about the electronic device or information about the nearby device; based on the information about the electronic device or the information about the nearby device, generate a query for crawling data; crawl data based on the query; and generate the question for performing the machine reading comprehension on the crawled data.

The instructions, when executed by the at least one processor individually or collectively, cause the electronic device to: based on the question, obtain the additional information by performing machine reading comprehension on the crawled data; and based on the additional information, provide the user with the response.

The additional information includes information related to a control action included in the utterance.

According to the utterance, the additional information including a reason for which the electronic device or the nearby device is unable to be controlled.

The additional information includes guidance for correcting a control action included in the utterance.

According to an aspect of the disclosure, a method of operating an electronic device includes receiving, from a user, an utterance for controlling the electronic device or a nearby device; based on an analysis result of the utterance, obtaining information utilized for machine reading comprehension; obtaining additional information related to the utterance by performing the machine reading comprehension based on the information; and based on the obtaining the additional information, providing the user with a response corresponding to the utterance.

The information utilized for the machine reading comprehension is obtained when the utterance includes at least one of: an unsupported control command; an unsupported parameter value; and a parameter preset to provide the additional information.

The information utilized for the machine reading comprehension includes at least one of information about the electronic device, information about the nearby device, a query for crawling data, crawled data, or a question for obtaining a machine reading comprehension result.

The method further includes based on the information being obtained, generate a query for crawling data; crawl data based on the query; and generate a question for performing the machine reading comprehension on the crawled data. The information utilized for the machine reading comprehension is about the electronic device or the nearby device.

The additional information is obtained by performing the machine reading comprehension on the crawled data based on the question.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment;

FIG. 2 is a block diagram illustrating an integrated intelligence system according to an embodiment;

FIG. 3 is a diagram illustrating a form in which relationship information on relationships between concepts and actions is stored in a database (DB), according to an embodiment;

FIG. 4 is a diagram illustrating a screen of an electronic device processing a received voice input through an intelligent app, according to an embodiment;

FIG. 5 is a diagram illustrating an operation of an electronic device to process an utterance of a user, according to an embodiment;

FIG. 6 is a schematic block diagram of an electronic device according to an embodiment;

FIGS. 7 to 13 are diagrams illustrating an operation of an electronic device to process a user utterance, according to an embodiment; and

FIG. 14 is a flowchart of a method of operating an electronic device, according to an embodiment;

### DETAILED DESCRIPTION

Hereinafter, embodiments are described in detail with reference to the accompanying drawings. When describing the embodiments with reference to the accompanying drawings, like reference numerals refer to like components and a repeated description related thereto will be omitted.

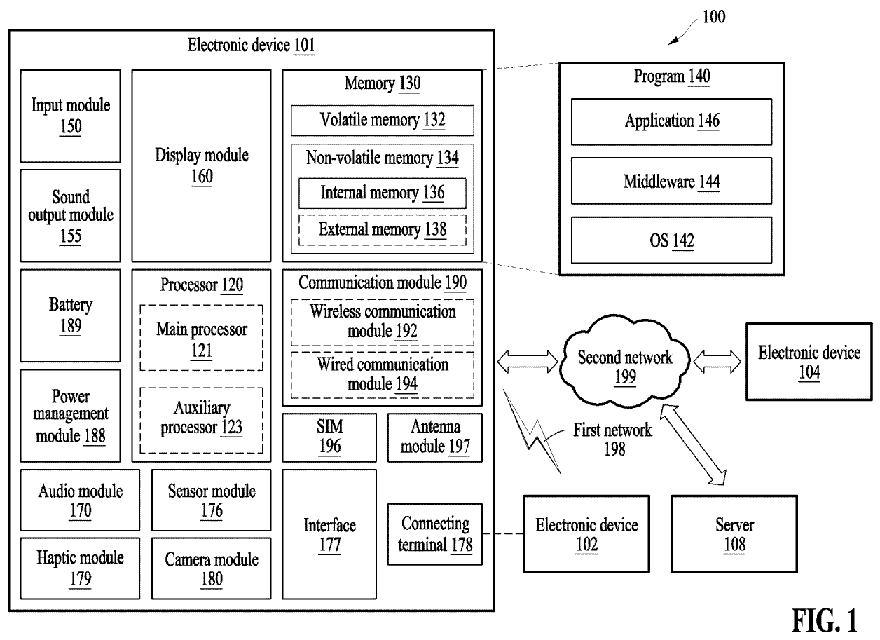

FIG. 1 is a block diagram of an electronic device 101 in a network environment 100 according to an embodiment. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., an NPU) may include a hardware structure specified for artificial intelligence (AI) model processing. An AI model may be generated through machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate form, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal or vice versa. According to an embodiment, the audio module 170 may obtain the sound via the input module 150, or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

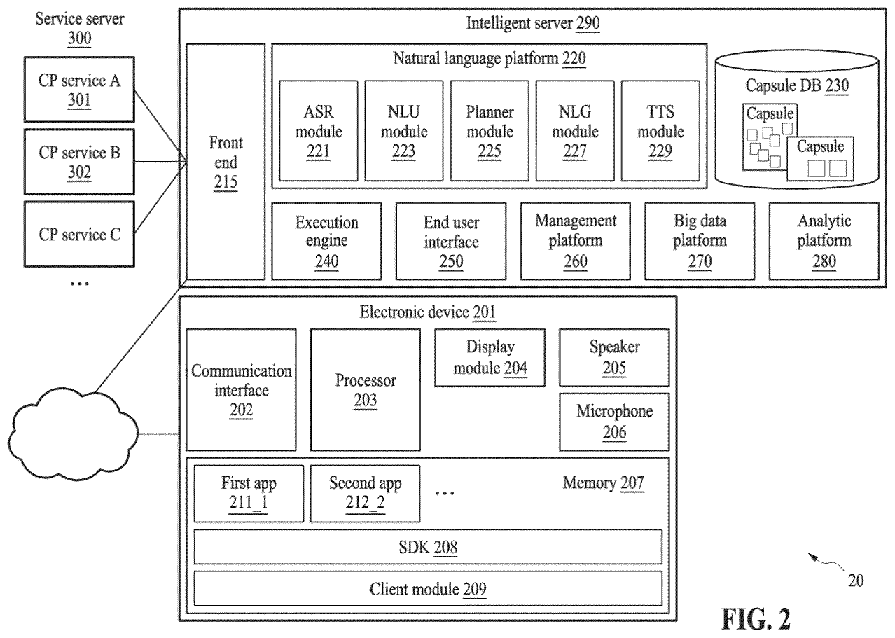

FIG. 2 is a block diagram illustrating an integrated intelligence system according to an embodiment.

Referring to FIG. 2, an integrated intelligence system 20 according to an embodiment may include an electronic device 201 (e.g., the electronic device 101 of FIG. 1), an intelligent server 200 (e.g., the server 108 of FIG. 1), and a service server 300 (e.g., the server 108 of FIG. 1).

The electronic device 201 according to an embodiment may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), or a smart speaker.

According to the shown embodiment, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), memory 207 (e.g., the memory 130 of FIG. 1), or a processor 203 (e.g., the processor 120 of FIG. 1). The components listed above may be operationally or electrically connected to one another.

The communication interface 202 according to an embodiment may be connected to an external device and configured to transmit and receive data to and from the external device. The microphone 206 according to an embodiment may receive a sound (e.g., a user utterance) and convert the sound into an electrical signal. The speaker 205 according to an embodiment may output the electrical signal as a sound (e.g., a speech).

The display module 204 according to an embodiment may be configured to display an image or video. The display module 204 according to an embodiment may also display a graphical user interface (GUI) of an app (or an application program) being executed. The display module 204 according to an embodiment may receive a touch input through a touch sensor. For example, the display module 204 may receive a text input through a touch sensor in an on-screen keyboard area displayed in the display module 204.

The memory 207 according to an embodiment may store a client module 209, a software development kit (SDK) 208, and a plurality of applications 211. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of applications 211 stored in the memory 207 according to an embodiment may be programs for performing designated functions. According to an embodiment, the plurality of applications 211 may include a first application 211_1 and a second application 211_2. According to an embodiment, each of the plurality of applications 211 may include a plurality of actions for performing a designated function. For example, the applications may include an alarm app, a messaging app, and/or a scheduling app. According to an embodiment, the plurality of applications 211 may be executed by the processor 203 to sequentially execute at least a portion of the plurality of actions.

The processor 203 according to an embodiment may control the overall operation of the electronic device 201. For example, the processor 203 may be electrically connected to the communication interface 202, the microphone 206, the speaker 205, and the display module 204 to perform a designated operation.

The processor 203 according to an embodiment may also perform the designated function by executing the program stored in the memory 207. For example, the processor 203 may execute at least one of the client module 209 or the SDK 208 to perform the following operation for processing a user input. The processor 203 may control the actions of the plurality of applications 211 through, for example, the SDK 208. The following operation which is the operation of the client module 209 or the SDK 208 may be performed by the processor 203.

The client module 209 according to an embodiment may receive a user input. For example, the client module 209 may receive a voice signal corresponding to a user utterance sensed through the microphone 206. As another example, the client module 209 may receive a touch input sensed through the display module 204. As still another example, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209 according to an embodiment may receive a result corresponding to the received user input. For example, when the intelligent server 200 is capable of calculating a result corresponding to the received user input, the client module 209 may receive the result corresponding to the received user input. The client module 209 may display the received result on the display module 204. Furthermore, the client module 209 may output the received result in an audio form through the speaker 205.

The client module 209 according to an embodiment may receive a plan corresponding to the received user input. The client module 209 may display results of executing a plurality of actions of an app according to the plan on the display module 204. For example, the client module 209 may sequentially display the results of executing the plurality of actions on the display module 204 and output the results in an audio form through the speaker 205. As another example, the electronic device 201 may display only a portion of the results of executing the plurality of actions (e.g., a result of the last action) on the display module 204 and output the portion of the results in an audio form through the speaker 205.

According to an embodiment, the client module 209 may receive a request for obtaining information necessary for calculating a result corresponding to the user input from the intelligent server 200. According to an embodiment, the client module 209 may transmit the necessary information to the intelligent server 200 in response to the request.

The client module 209 according to an embodiment may transmit information on the results of executing the plurality of actions according to the plan to the intelligent server 200. The intelligent server 200 may confirm that the received user input is correctly processed using the information on the results.

The client module 209 according to an embodiment may include a speech recognition module. According to an embodiment, the client module 209 may recognize a voice input for performing a limited function through the speech recognition module. For example, the client module 209 may execute an intelligent app for processing a voice input to perform an organic operation through a designated input (e.g., Wake up!).

The intelligent server 200 according to an embodiment may receive information related to a user voice input from the electronic device 201 through a communication network. According to an embodiment, the intelligent server 200 may change data related to the received voice input to text data. According to an embodiment, the intelligent server 200 may generate a plan for performing a task corresponding to the user voice input based on the text data.

According to an embodiment, the plan may be generated by an AI system. The AI system may be a rule-based system or a neural network-based system (e.g., a feedforward neural network (FNN) or a recurrent neural network (RNN)). Alternatively, the AI system may be a combination of the above-described systems or other AI systems. According to an embodiment, the plan may be selected from a set of pre-defined plans or may be generated in real time in response to a user request. For example, the AI system may select at least one plan from the pre-defined plans.

The intelligent server 200 according to an embodiment may transmit a result according to the generated plan to the electronic device 201 or transmit the generated plan to the electronic device 201. According to an embodiment, the electronic device 201 may display the result according to the plan on the display module 204. According to an embodiment, the electronic device 201 may display a result of executing an action according to the plan on the display module 204.

The intelligent server 200 according to an embodiment may include a front end 215, a natural language platform 220, a capsule database (DB) 230, an execution engine 240, an end UI 250, a management platform 260, a big data platform 270, or an analytic platform 280.

The front end 215 according to an embodiment may receive the received user input from the electronic device 201. The front end 215 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 according to an embodiment may convert data related to the voice input received from the electronic device 201 into text data. The NLU module 223 according to an embodiment may determine a domain (and/or intent information) corresponding to a voice input (e.g., a user utterance) based on the text data of the voice input. The domain may correspond to a category (or a service) associated with an action (or a function) that the user intends to execute using a device. The domain may be classified based on a service (e.g., an app) related to text. For example, a Gracenote domain may correspond to a music search service (e.g., a Gracenote service). A Melon domain may correspond to a music streaming service (e.g., a Melon service). The domain may be associated with intent information corresponding to text. The NLU module 223 according to an embodiment may discern a user intent using the text data of the voice input. For example, the NLU module 223 may discern an intent of a user by performing syntactic analysis or semantic analysis on a user input in the form of text data. The NLU module 223 according to an embodiment may discern a meaning of a word extracted from the user input using a linguistic feature (e.g., a grammatical element) of a morpheme or a phrase and may determine the intent of the user by matching the discerned meaning of the word to an intent. The NLU module 223 may obtain intent information corresponding to a user utterance. The intent information may be information indicating an intention of the user determined through an analysis of the text data. The intent information may include information indicating an action (or function) that the user intends to execute using a device. A slot may be detailed information associated with intent information. A slot may be obtained based on a domain corresponding to an utterance. A slot may be variable information necessary to perform an action. In an embodiment, variable information included in a slot may include a named entity.

The planner module 225 according to an embodiment may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions, or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 according to an embodiment may change designated information to a text form. The information changed to the text form may be in the form of a natural language utterance. The TTS module 229 according to an embodiment may change information in a text form to information in a speech form.

According to an embodiment, some or all of the functions of the natural language platform 220 may be implemented in the electronic device 201 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when a plurality of plans corresponding to the voice input are present. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 201. According to an embodiment, the capsule DB 230 may include a vocabulary registry that stores vocabulary information included in capsule information. According to an embodiment, the capsule DB 230 may include a dialog registry that stores information on a dialog (or an interaction) with a user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with a user. The developer tool may include a follow-up editor capable of activating a subsequent goal and editing a subsequent utterance that provides hints. The subsequent goal may be determined based on a currently configured goal, a preference of a user, or environmental conditions. In an embodiment, the capsule DB 230 may also be implemented in the electronic device 201.

The execution engine 240 according to an embodiment may calculate a result using the generated plan. The end UI 250 may transmit the calculated result to the electronic device 201. Accordingly, the electronic device 201 may receive the result and provide the received result to the user. The management platform 260 according to an embodiment may manage information used in the intelligent server 200. The big data platform 270 according to an embodiment may collect data of the user. The analytic platform 280 according to an embodiment may manage a quality of service (QoS) of the intelligent server 200. For example, the analytic platform 280 may manage the components and processing rate (or efficiency) of the intelligent server 200.

The service server 300 according to an embodiment may provide a designated service (e.g., food order or hotel reservation) to the electronic device 201. According to an embodiment, the service server 300 may be a server operated by a library administrator. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 201 may provide various intelligent services to the user in response to a user input. The user input may include, for example, an input through a physical button, a touch input, or a voice input.

In an embodiment, the electronic device 201 may provide a speech recognition service through an intelligent app (or a speech recognition app) stored therein. In this case, for example, the electronic device 201 may recognize a user utterance or a voice input received through the microphone and provide a service corresponding to the recognized voice input to the user.

In an embodiment, the electronic device 201 may perform a designated action alone or together with the intelligent server and/or the service server, based on the received voice input. For example, the electronic device 201 may execute an app corresponding to the received voice input and perform a designated action through the executed app.

In an embodiment, when the electronic device 201 provides a service together with the intelligent server 200 and/or the service server 300, the electronic device 201 may detect a user utterance using the microphone 206 and generate a signal (or voice data) corresponding to the detected user utterance. The electronic device 201 may transmit the voice data to the intelligent server 200 using the communication interface 202.

The intelligent server 200 according to an embodiment may generate, as a response to the voice input received from the electronic device 201, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may be defined as parameters that are input for execution of the plurality of actions or result values that are output by execution of the plurality of actions. The plan may include connection information on connections between the plurality of actions and the plurality of concepts.

The electronic device 201 according to an embodiment may receive the response using the communication interface 202. The electronic device 201 may output a voice signal generated inside the electronic device 201 to the outside using the speaker 205, or may output an image generated inside the electronic device 201 to the outside using the display module 204.

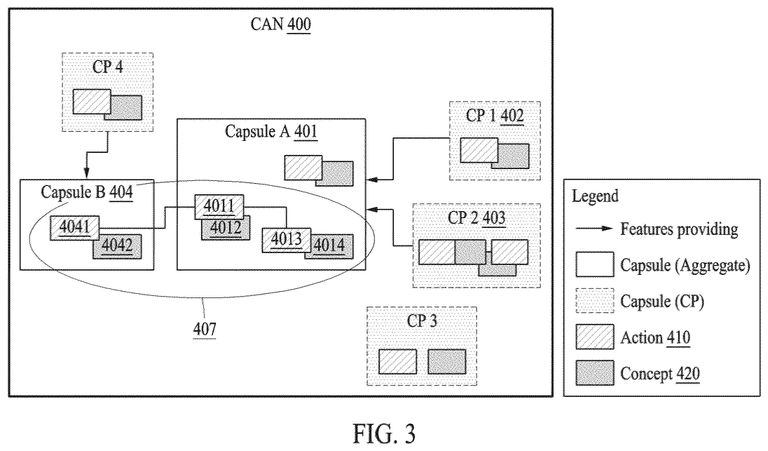

FIG. 3 is a diagram illustrating a form in which relationship information on relationships between concepts and actions is stored in a DB, according to various embodiments.

A capsule DB (e.g., the capsule DB 230 of FIG. 2) of the intelligent server (e.g., the intelligent server 200 of FIG. 2) may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains. According to an embodiment, one capsule (e.g., the capsule A 401) may correspond to one domain (e.g., a location (geo) or an application). In addition, one capsule may correspond to at least one service provider (e.g., CP 1 402 or CP 2 403) for performing a function for a domain related to the capsule. According to an embodiment, one capsule may include at least one action 410 and at least one concept 420 to perform a designated function.

A natural language platform (e.g., the natural language platform 220 of FIG. 2) may generate a plan for performing a task corresponding to the received voice input using the capsules stored in the capsule DB. For example, a planner module (e.g., the planner module 225 of FIG. 2) of the natural language platform may generate a plan using the capsules stored in the capsule DB. For example, a plan 407 may be generated using actions 4011 and 4013 and concepts 4012 and 4014 of the capsule A 401 and an action 4041 and a concept 4042 of the capsule B 404.

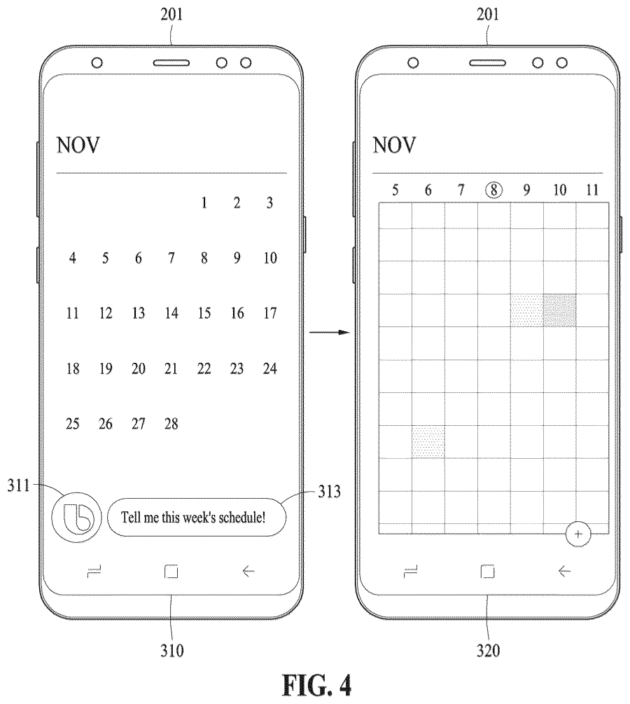

FIG. 4 is a diagram illustrating a screen of an electronic device processing a received voice input through an intelligent app, according to various embodiments.

An electronic device 201 may execute an intelligent app to process a user input through an intelligent server (e.g., the intelligent server 200 of FIG. 2).

According to an embodiment, on a screen 310, when a designated voice input (e.g., Wake up!) is recognized or an input through a hardware key (e.g., a dedicated hardware key) is received, the electronic device 201 may execute an intelligent app for processing the voice input. The electronic device 201 may execute the intelligent app, for example, in a state in which a scheduling app is executed. According to an embodiment, the electronic device 201 may display an object (e.g., an icon) 311 corresponding to the intelligent app on the display module 204 (e.g., the display module 160 of FIG. 1 or the display module 204 of FIG. 2). According to an embodiment, the electronic device 201 may receive a voice input by a user utterance. For example, the electronic device 201 may receive a voice input of “Tell me this week's schedule.” According to an embodiment, the electronic device 201 may display a UI 313 (e.g., an input window) of the intelligent app in which text data of the received voice input is displayed on the display module 204.

According to an embodiment, on a screen 320, the electronic device 201 may display a result corresponding to the received voice input on the display module 204. For example, the electronic device 201 may receive a plan corresponding to the received user input and display “this week's schedule” on the display module 204 according to the plan.

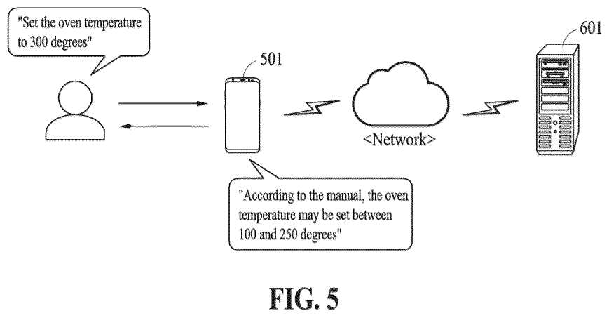

FIG. 5 is a diagram illustrating an operation of an electronic device to process an utterance of a user, according to an embodiment.

Referring to FIG. 5, according to an embodiment, an electronic device 501 may include at least some components of the electronic device 101 described with reference to FIG. 1 and the electronic device 201 described with reference to FIG. 2. An intelligent server 601 may include at least some components of the intelligent server 200 described with reference to FIG. 2. With respect to the electronic device 501 and the intelligent server 601, repeated descriptions provided with reference to FIGS. 1 to 4 are omitted.

According to an embodiment, the electronic device 501 (e.g., the electronic device 101 of FIG. 1 or the electronic device 201 of FIG. 2) may be connected to the intelligent server 601 (e.g., the intelligent server 200 of FIG. 2) via a LAN, a WAN, a value-added network (VAN), a mobile radio communication network, a satellite communication network, or any combination thereof. The electronic device 501 and the intelligent server 601 may communicate with each other through a wired communication method or a wireless communication method (e.g., a wireless LAN (Wi-Fi), Bluetooth, Bluetooth low energy, ZigBee, Wi-Fi Direct (WFD), ultra-wideband (UWB), infrared data association (IrDA), and near-field communication (NFC)). The electronic device (501) may communicate with a nearby device (e.g., the electronic device 102 of FIG. 1 or the electronic device 104 of FIG. 1) positioned around the electronic device 501.

According to an embodiment, the electronic device 501 may be implemented as at least one of a smartphone, a tablet personal computer (PC), a mobile phone, a speaker (e.g., an AI speaker), a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device.

According to an embodiment, the electronic device 501 may obtain a voice signal corresponding to an utterance of a user and may transmit the voice signal to the intelligent server 601. The intelligent server 601 may obtain text data corresponding to the utterance of the user based on the voice signal. The text data may be obtained by converting a voice part into computer-readable text by performing ASR on the voice signal. The intelligent server 601 may analyze the utterance of the user using the text data. The intelligent server 601 may perform a required function using an analysis result (e.g., intent information, an entity, and/or a capsule) or may provide a response (e.g., a question and an answer) to be provided to a user to a device (e.g., the electronic device 501). The intelligent server 601 may be implemented as software. Some or all of the intelligent server 601 may be implemented in the electronic device 501 and/or the intelligent server 601 (e.g., the intelligent server 200 of FIG. 2). On-device AI for processing an utterance without communication with the intelligent server 601 may be installed in the electronic device 501. Components, such as the natural language platform 220 described with reference to FIGS. 2 to 4, may be implemented in the electronic device 501.

According to an embodiment, the ASR module 221 (e.g., the ASR module of FIG. 2) included in the natural language platform 220 may convert a user utterance into text data. The NLU module 223 included in the natural language platform 220 may determine a domain (and/or intent information) corresponding to the user utterance based on the text data corresponding to the user utterance.

According to an embodiment, the domain may correspond to a category (or a service) associated with an action (or a function) that the user intends to execute using a device. The domain may be classified based on a service (e.g., an app) related to a user utterance. For example, the Gracenote domain may correspond to a music search service (e.g., the Gracenote service). For example, the Melon domain may correspond to a music play service (e.g., the Melon service). A plurality of user utterances may be respectively processed based on respective domains corresponding thereto. A task corresponding to a user utterance may be processed in a capsule (e.g., an application). One capsule may correspond to one domain. One capsule may include at least one action for performing a designated function and at least one concept. A capsule may process a task corresponding to a user utterance based on intent information. The intent information may be determined in the capsule or in an NLU module.

According to an embodiment, the intent information may be information indicating the intent of the user determined by interpreting text data. The intent information may include information indicating an action (or a function) that the user intends to execute using a device.

According to an embodiment, a slot may be detailed information related to the intent information. The slot may be variable information necessary to perform an action. For example, when the text converted from a voice input of the user is “What time is it in San Francisco?,” the domain may be a ‘date & time domain,’ the intent information may correspond to ‘date/time information provision,’ the slot may be ‘San Francisco,’ and the capsule (e.g., an application) may provide the user with the time in San Francisco. For example, when the text converted from the voice input of the user is “How's the weather here?,” the domain may be a ‘weather domain,’ the intent information may correspond to ‘weather information provision,’ and the slot may be ‘current location.’ The capsule may provide the user with the weather at the current location. For example, when the text converted from the voice input of the user is “Set the oven temperature to 300 degrees,” the domain may be a ‘device control domain (e.g., SmarThings),’ the intent information may correspond to ‘oven control,’ the slot may be ‘300 degrees,’ and the capsule may attempt to set the oven temperature to 300 degrees.

According to an embodiment, the electronic device 501 may utilize machine reading comprehension for voice assistant-based device control. The electronic device 501 may obtain additional information through machine reading comprehension when additional information is needed to respond to a user utterance. A user utterance utilizing a voice assistant may be classified into two categories. The two categories may include a command category for controlling an electronic device or causing the electronic device to control another nearby device and a question-and-answer category for querying through the electronic device and obtaining an answer. The electronic device 501 may utilize machine reading comprehension to handle a user utterance corresponding to a command category.

Referring to FIG. 5, according to an embodiment, the electronic device 501 may receive an utterance (e.g., “Set the oven temperature to 300 degrees”) from the user. The utterance (e.g., “Set the oven temperature to 300 degrees”) may be an utterance that controls a nearby device (e.g., an oven) (not shown). The utterance (e.g., “Set the oven temperature to 300 degrees”) may include an unsupported parameter value (e.g., 300 degrees) (e.g., when a slot value (e.g., 300) exceeds a setting range). Additional information may be needed to respond to the utterance, so the electronic device 501 may obtain additional information (e.g., settable temperature of the oven) (e.g., 100 degrees or more and 250 degrees or less) through machine reading comprehension. Based on the additional information (e.g., the settable temperature of the oven is 100 degrees or more and 250 degrees or less), the electronic device 501 may provide the user with a response (e.g., “According to the manual, the oven temperature may be set between 100 and 250 degrees”) corresponding to the utterance. The electronic device 501 may utilize machine reading comprehension for voice assistant-based device control.

According to an embodiment, the electronic device 501 may provide a reason for a failure (and/or a reason for a success) of a voice assistant action by utilizing a machine reading comprehension result. The electronic device 501 may enhance usability and user understanding of the voice assistant action by providing the reason for the failure (and/or the reason for the success) of the voice assistant action. The electronic device 501 may guide the user to a correct control command by utilizing the machine reading comprehension result.

According to an embodiment, some or all operations performed by the electronic device 501 may be performed by the electronic device 501 and/or the intelligent server 601. Hereinafter, a description is provided based on an assumption that the electronic device 501 performs the operations.

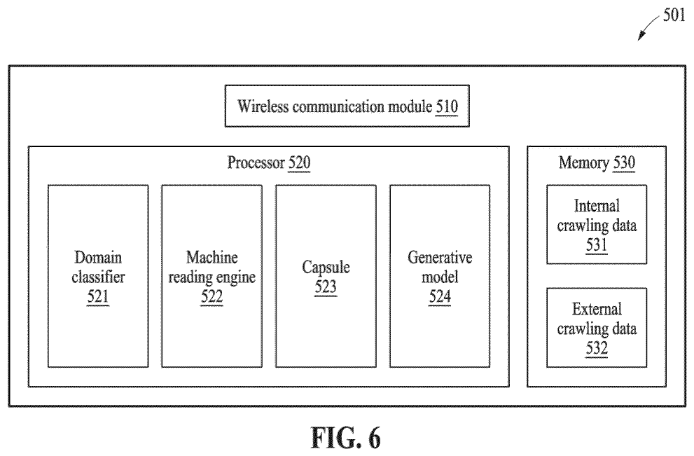

FIG. 6 is a schematic block diagram of an electronic device according to an embodiment.

Referring to FIG. 6, according to an embodiment, the electronic device 501 may include at least some components of the electronic device 101 described with reference to FIG. 1 and the electronic device 201 described with reference to FIG. 2. As described above, on-device AI for processing an utterance without communication with an intelligent server (e.g., the intelligent server 200 of FIG. 2 or the intelligent server 601 of FIG. 5) may be installed on the electronic device 501. In other words, the natural language platform 220 described with reference to FIGS. 2 to 4 may be implemented in the electronic device 501. With respect to the electronic device 501, repeated descriptions provided with reference to FIGS. 1 to 4 are omitted.

According to an embodiment, the electronic device 501 may include a wireless communication module 510 (e.g., the wireless communication module 192 of FIG. 1). The wireless communication module 510 may communicate with a nearby device (e.g., the electronic device 102 of FIG. 1 or the electronic device 104 of FIG. 1) positioned around the electronic device 501. The electronic device 501 may include a processor 520 (e.g., the processor 120 of FIG. 1 or the processor 203 of FIG. 2). The electronic device 501 may include memory 530 (e.g., the memory 130 of FIG. 1 or the memory 207 of FIG. 2). The processor 520 (e.g., an AP) may execute instructions by accessing the memory 530.

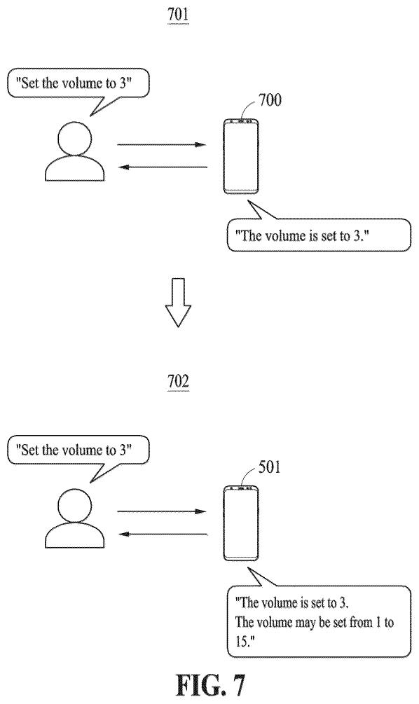

According to an embodiment, the memory 530 may include one or more memories. The instructions stored in the memory 530 may be stored in one memory. The instructions stored in the memory 530 may be divided and stored in a plurality of memories. The instructions stored in the memory 530 may be executed by the processor 520 and cause the electronic device 501 to perform and/or control the operations of the electronic device 501 described with reference to FIGS. 1 to 6 and the operations of the electronic device 501 described with reference to FIGS. 7 to 14.

According to an embodiment, the processor 520 may be implemented as a system on chip (SoC) or circuitry (e.g., processing circuitry) such as an integrated circuit (IC). The processor 520 may include at least one processor. For example, the processor 520 may include a combination of one or more processors, such as a CPU, a GPU, a micro processing unit (MPU), an AP, and a CP. The instructions stored in the memory 530 may be executed by one processor and cause the communication device 500 to perform and/or control the operations of the electronic device 501 described with reference to FIGS. 1 to 6 and the operations of the electronic device 501 described with reference to FIGS. 7 to 14. The instructions stored in the memory 530 may be executed by a plurality of processors to cause the electronic device 501 to perform and/or control the operations of the electronic device 501 described with reference to FIGS. 1 to 6 and the operations of the electronic device 501 described with reference to FIGS. 7 to 14.

According to an embodiment, the instructions may be executed by the processor 520 individually or collectively to cause the electronic device 501 to provide a user with a response. The memory 530 may store a variety of data used by at least one component (e.g., the processor 520) of the electronic device 501. The memory 530 may store (or cache) data crawled by the processor 520 for machine reading comprehension.

According to an embodiment, the wireless communication module 510 may receive the user utterance (e.g., “Set the oven temperature to 300 degrees”). The user utterance (e.g., “Set the oven temperature to 300 degrees”) may be an utterance that controls the electronic device 501 or a nearby device (e.g., an oven).

According to an embodiment, a domain classifier 521 may determine a domain (e.g., a device control domain) corresponding to the user utterance. The domain classifier 521 may determine a capsule (e.g., an application) (e.g., SmarThings) in which the user utterance is processed by determining the domain corresponding to the user utterance. An action of the domain classifier 521 may correspond to an action of an NLU module (e.g., the NLU module 223 of FIG. 2). The domain classifier 521 may be implemented within the NLU module or may be implemented as a separate module from the NLU module.

According to an embodiment, an output of the domain classifier 521 may include an analysis result (e.g., a domain, intent information, and a slot) of an utterance. The utterance (e.g., “Set the oven temperature to 300 degrees”) may include an unsupported parameter value (e.g., 300 degrees) (e.g., this corresponds to a case in which a slot value (e.g., 300) exceeds a setting range). Additional information may be needed to respond to the utterance, so the processor 520 may determine to perform machine reading comprehension. A case in which the processor 520 determines whether to perform machine reading comprehension may correspond to a case in which the utterance includes an unsupported control command (e.g., a case in which there is no intent information matching the user utterance or the domain (or capsule) in which the user utterance is processed is not determined). A case in which the processor 520 determines whether to perform machine reading comprehension may correspond to a case (e.g., a case in which additional information is provided according to the pre-settings of an electronic device manufacturer) in which the utterance includes a parameter preset to provide additional information.

According to an embodiment, the processor 520 may obtain information utilized for machine reading comprehension. Based on an analysis result of the utterance, the processor 520 may obtain information on the electronic device or information (e.g., model information of an oven) (e.g., model name HSB-N700B) on a nearby device. Based on the information on the electronic device or the information on the nearby device, the processor 520 may generate a query (e.g., Query (oven temperature, range, HSB-N700B)) for crawling data. Based on the query (e.g., Query (oven temperature, range, HSB-N700B)), the processor 520 may crawl data (e.g., HSB-N700B model manual).

According to an embodiment, the processor 520 may store (or cache) the crawled data (e.g., HSB-N700B model manual) in the memory 530. Internal crawling data 531 stored (or cached) in the memory 530 may be data pre-stored in the electronic device 501. The internal crawling data 531 may include a setting value of the electronic device 501 and/or data of a nearby device connected to the electronic device 501. External crawling data 532 may be data stored outside the electronic device 501. The external crawling data 532 may include a manual for a home appliance and/or a post posted on the website of a home appliance manufacturer.

According to an embodiment, the processor 520 may generate a question (e.g., “Temperature range of the HSB-N700B model?”) to perform machine reading comprehension on the crawled data (e.g., HSB-N700B model manual). The question may be structured in the form of a query.

According to an embodiment, a machine reading comprehension engine 522 may obtain (or extract) additional information (e.g., settable temperature of the HSB-N700B model) (e.g., 100 degrees or more and 250 degrees or less) by performing machine reading comprehension on the crawled data (e.g., HSB-N700B model manual) based on the question (e.g., temperature range of the HSB-N700B model?). When there are two or more pieces of extracted additional information, the machine reading comprehension engine 522 may also rank the pieces of additional information.

According to an embodiment, the machine reading comprehension engine 522 may convert the additional information into a format (e.g., in the form of intent information and slots) usable by a capsule 523. Based on the additional information, the machine reading comprehension engine 522 may also directly generate a response to provide to the user. The machine reading comprehension engine 522 may convert the additional information into a format (e.g., a prompt form) usable by a generative model 524.

According to an embodiment, based on the additional information (e.g., the settable temperature of the oven) (e.g., 100 degrees or more and 250 degrees or less), the capsule 523 (e.g., an application) may process the utterance (e.g., “Set the oven temperature to 300 degrees”). The capsule 523 may be stored in the form of the capsule DB 230 of FIG. 2. Although only one capsule (e.g., 523) corresponding to an utterance is shown in FIG. 6, it should be noted that a set of capsules may be stored in the capsule DB 230.

According to an embodiment, the electronic device 501 may utilize machine reading comprehension for voice assistant-based device control. Before performing a voice assistant action of a capsule (e.g., an application), the electronic device 501 may check in advance whether the capsule may perform the voice assistant action and provide a reason for a failure (and/or a reason for a success) of the voice assistant action.

According to an embodiment, the electronic device 501 may perform machine reading comprehension after performing a domain classification action and performing a voice assistant action in a classified domain to provide the reason for the failure (and/or the reason for the success) of the voice assistant action for the utterance.

According to an embodiment, based on support specifications of the electronic device 501, the electronic device 501 may provide information on whether the user utterance is supported. When the user receives a response indicating that an unsupported utterance is not supported, the user may give up on that utterance. However, by providing information on whether the user utterance is supported, the electronic device 501 may elicit a follow-up utterance from the user.

According to an embodiment, the electronic device 501 may generate an answer based on a result of performing machine reading comprehension, thereby reducing the effort required for a developer to predefine an answer for each application. Additionally, the electronic device 501 may provide various forms of answers to the user by generating answers based on the result of performing machine reading comprehension.

According to an embodiment, the electronic device 501 may utilize a manual or internal/external databases for generating answers independently of an application, thereby reducing the burden on an application developer and enabling answers through interworking with other devices.

FIGS. 7 to 13 are diagrams illustrating an operation of an electronic device to process a user utterance, according to an embodiment.

Referring to FIG. 7, in a situation 701, an electronic device 700 may receive, from a user, an utterance (e.g., “Set the volume to 3”). The utterance (e.g., “Set the volume to 3”) may be an utterance that controls (e.g., volume control) the electronic device 700. The electronic device 700 may provide the user with a response (e.g., “The volume is set to 3”) corresponding to the utterance.

According to an embodiment, in a situation 702, the electronic device 501 may receive, from the user, the utterance (e.g., “Set the volume to 3”). The utterance (e.g., “Set the volume to 3”) may be an utterance that controls (e.g., volume control) the electronic device 501. The electronic device 501 may obtain additional information (e.g., a settable volume range of the electronic device) (e.g., 1 to 15) through machine reading comprehension. The additional information may include information associated with a control action included in the utterance. Based on the additional information (e.g., the settable volume range of the electronic device is 1 to 15), the electronic device 501 may provide the user with a response (e.g., “The volume is set to 3. The volume may be set from 1 to 15.”). The electronic device 501 may utilize machine reading comprehension for voice assistant-based device control. The electronic device 501 may provide a reason for a success of a voice assistant action by utilizing a result of machine reading comprehension.

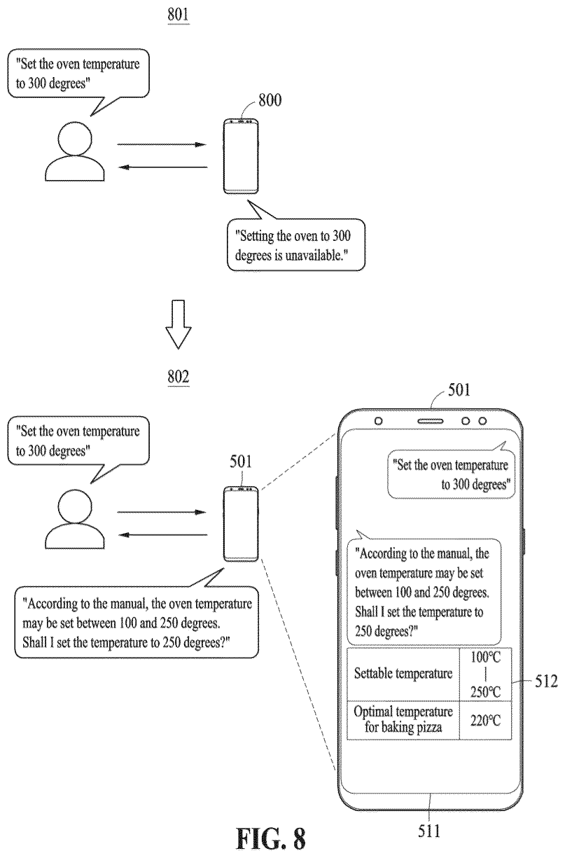

Referring to FIG. 8, in a situation 801, an electronic device 800 may receive, from a user, an utterance (e.g., “Set the oven temperature to 300 degrees”). The utterance (e.g., “Set the oven temperature to 300 degrees”) may be an utterance that controls (e.g., setting the temperature) a nearby device (e.g., an oven). The utterance (e.g., “Set the oven temperature to 300 degrees”) may include an unsupported parameter value (e.g., 300 degrees) (e.g., when a slot value (e.g., 300) exceeds a setting range). The electronic device 800 may not process an utterance including an unsupported parameter value, and, accordingly, may need to provide the user with a rejection response (e.g., “Setting the oven to 300 degrees is unavailable”).

According to an embodiment, in a situation 802, the electronic device 501 may receive, from the user, the utterance (“Set the oven temperature to 300 degrees”). The utterance (e.g., “Set the oven temperature to 300 degrees”) may be an utterance that controls a nearby device (e.g., an oven) (not shown). The utterance (e.g., “Set the oven temperature to 300 degrees”) may include an unsupported parameter value (e.g., 300 degrees) (e.g., when a slot value (e.g., 300) exceeds a setting range). Additional information may be needed to respond to the utterance, so the electronic device 501 may obtain additional information (e.g., the settable temperature of the oven) (e.g., 100 degrees or more and 250 degrees or less) through machine reading comprehension. The additional information may include a reason for which the electronic device or the nearby device is unable to be controlled according to the utterance. The additional information may include guidance on correcting a control action included in the utterance. Based on the additional information (e.g., the settable temperature of the oven is 100 degrees or more and 250 degrees or less), the electronic device 501 may provide the user with a response (e.g., “According to the manual, the oven temperature may be set between 100 and 250 degrees. Shall I set the temperature to 250 degrees?”) corresponding to the utterance. The electronic device 501 may present, via the screen 511, text, a diagram, and/or an image obtained (e.g., captured or crawled) from a manual as a UI 512. The electronic device 501 may utilize machine reading comprehension for voice assistant-based device control. The electronic device 501 may provide a reason for a failure of a voice assistant action by utilizing a result of machine reading comprehension. The electronic device 501 may guide the user to a correct control command.

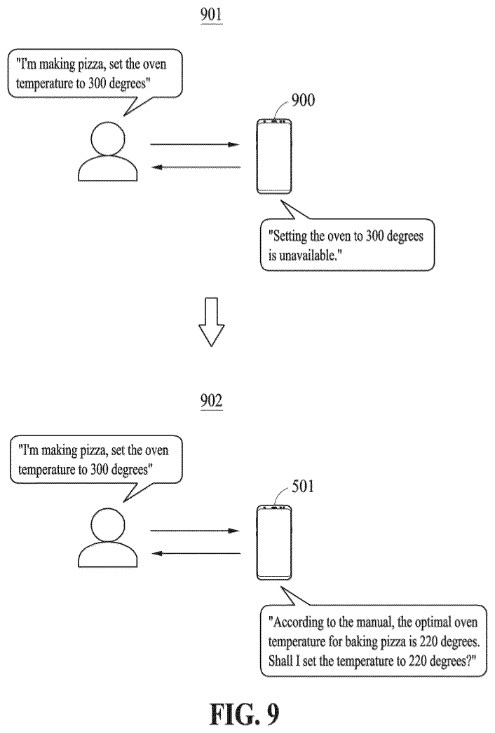

Referring to FIG. 9, a situation 901, similar to the situation 801, may include an unsupported parameter value (e.g., 300 degrees) in an utterance (e.g., “I'm making pizza, set the oven temperature to 300 degrees”). The electronic device 900 may not process an utterance including the unsupported parameter value, and, accordingly, may need to provide the user with a rejection response (e.g., “Setting the oven to 300 degrees is unavailable”).

According to an embodiment, in a situation 902, the electronic device 501 may obtain additional information (e.g., the temperature of an oven optimized for making pizza) (e.g., 220 degrees) through machine reading comprehension. Based on an utterance analysis result (e.g., oven temperature for making pizza), the electronic device 501 may reduce a machine reading comprehension search space. Based on the additional information (e.g., the temperature of the oven for making pizza is 220 degrees), the electronic device 501 may provide a user with a response (e.g., “According to the manual, the optimal oven temperature for baking pizza is 220 degrees. Shall I set the temperature to 220 degrees?”) corresponding to the utterance.

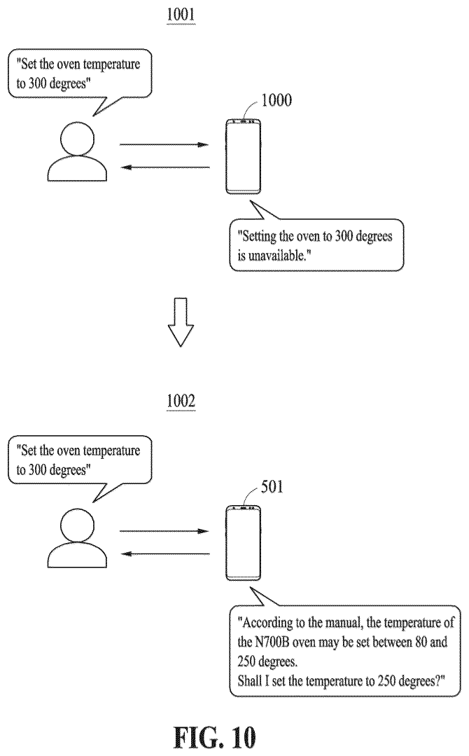

Referring to FIG. 10, in a situation 1001, similar to the situations 801 and 901, an utterance (e.g., “Set the oven temperature to 300 degrees”) may include an unsupported parameter value (e.g., 300 degrees). An electronic device 1000 may not process an utterance including an unsupported parameter value, and, accordingly, may need to provide the user with a rejection response (e.g., “Setting the oven to 300 degrees is unavailable”).

According to an embodiment, in a situation 1002, the electronic device 501 may obtain additional information (e.g., settable temperature of the N700B oven) (e.g., 80 degrees or more and 250 degrees or less) through machine reading comprehension. The electronic device 501 may on its own crawl and utilize information (e.g., model name N700B) of a nearby device. Based on the additional information (e.g., the settable temperature of the N700B oven is 80 degrees or more and 250 degrees or less), the electronic device 501 may provide the user with a response (e.g., “According to the manual, the temperature of the N700B oven may be set between 80 and 250 degrees. Shall I set the temperature to 250 degrees?”) corresponding to the utterance.

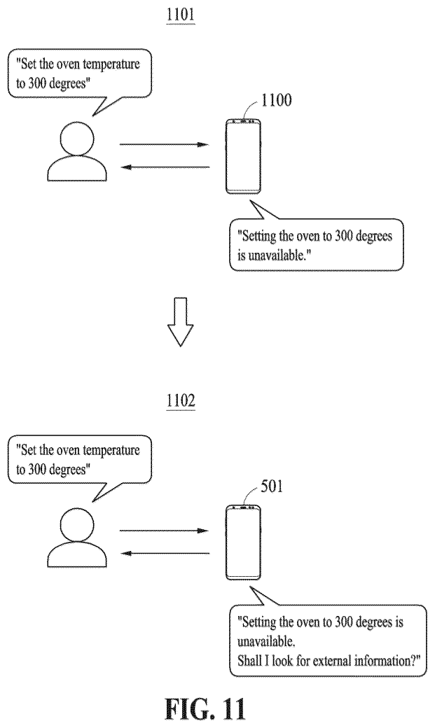

Referring to FIG. 11, in a situation 1101, similar to the situations 801, 901, and 1001, an utterance (e.g., “Set the oven temperature to 300 degrees”) may include an unsupported parameter value (e.g., 300 degrees). The electronic device 1000 may not process an utterance including an unsupported parameter value, and, accordingly, may need to provide the user with a rejection response (e.g., “Setting the oven to 300 degrees is unavailable”).

According to an embodiment, in a situation 1102, the electronic device 501 may ask the user a question (e.g., “Setting the oven to 300 degrees is unavailable”). Shall I look for external information?) to determine whether to perform machine reading comprehension. The electronic device 501 may elicit a subsequent utterance from the user and save resources of the electronic device 501 by performing machine reading comprehension only at a request of the user.

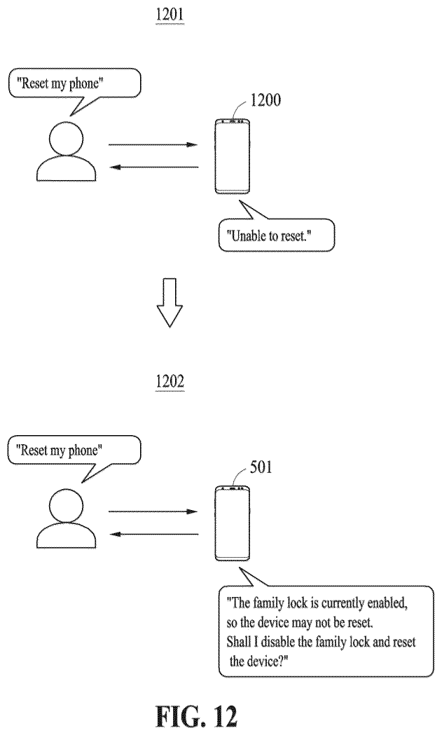

Referring to FIG. 12, in a situation 1201, an electronic device 1200 may receive, from a user, an utterance (e.g., “Reset my phone”). The utterance (e.g., “Reset my phone”) may be an utterance that controls (e.g., resets) the electronic device 1200. The utterance (e.g., “Reset my phone”) may not be supported depending on an external setting. The electronic device 1200 is only able to provide the user with a rejection response (e.g., “Unable to reset”) for the unsupported utterance.

According to an embodiment, in a situation 1202, the electronic device 501 may provide the user with information about an external setting (e.g., the electronic device 501 is in a family lock state). The electronic device 501 may provide a reason for a failure of a voice assistant action. The electronic device 501 may provide the user with setting information that the user is not aware of. Based on the external setting information (e.g., the electronic device 501 is in a family lock state), the electronic device 501 may provide the user with a response (e.g., “The family lock is currently enabled, so the device may not be reset. Shall I disable the family lock and reset the device?”) corresponding to the utterance.

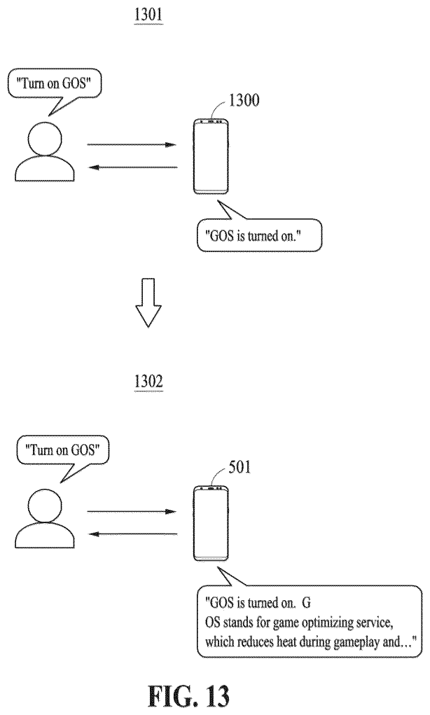

Referring to FIG. 13, in a situation 1301, an electronic device 1300 may receive, from a user, an utterance (e.g., “Turn on game optimizing service (GOS)”). The utterance (e.g., “Turn on GOS”) may be an utterance that controls the electronic device 1300. The electronic device 1300 may only provide the user with a simple response (e.g., “GOS is turned on”) corresponding to the utterance.

According to an embodiment, in a situation 1302, the electronic device 501 may receive the utterance (e.g., “Turn on GOS”). The utterance (e.g., “Turn on GOS”) may be an utterance that controls the electronic device 501. The utterance (e.g., “Turn on GOS”) may include a parameter preset to provide additional information (e.g., a case in which additional information is provided based on the pre-settings of an electronic device manufacturer). The electronic device 501 may obtain additional information (e.g., GOS-related information) through machine reading comprehension. Based on the additional information (e.g., GOS-related information), the electronic device 501 may provide the user with a response (e.g., “GOS is turned on. GOS stands for game optimizing service, which reduces heat during gameplay and . . . ”) corresponding to the utterance. The electronic device 501 may utilize machine reading comprehension for voice assistant-based device control.

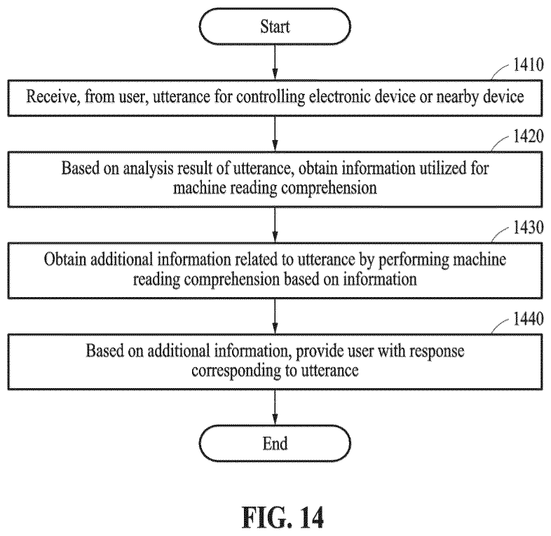

FIG. 14 is a flowchart of a method of operating an electronic device, according to an embodiment.

Operations 1410 to 1440 may be performed sequentially but not necessarily. For example, operations 1410 to 1440 may be performed in different orders, and at least two operations may be performed in parallel.

According to an embodiment, it may be understood that operations 1410 to 1440 may be performed by a processor (e.g., the processor 520 of FIG. 6) of an electronic device (e.g., the electronic device 501 of FIG. 6).

In operation 1410, the electronic device (e.g., the electronic device 501 of FIG. 5) according to an embodiment may receive, from a user, an utterance for controlling the electronic device 501 or a nearby device (e.g., the electronic device 102 of FIG. 1 or the electronic device 104 of FIG. 1).

In operation 1420, based on an analysis result of the utterance, the electronic device 501 according to an embodiment may obtain information utilized for machine reading comprehension.

In operation 1430, the electronic device 501 according to an embodiment may obtain additional information related to the utterance by performing machine reading comprehension based on information utilized for machine reading comprehension.

In operation 1440, based on the additional information, the electronic device 501 according to an embodiment may provide the user with a response corresponding to the utterance.

An electronic device (e.g., the electronic device 101 of FIG. 1, the electronic device 201 of FIG. 2, or the electronic device 501 of FIG. 5) according to an embodiment may include at least one wireless communication module (e.g., the wireless communication module 192 of FIG. 1 or the wireless communication module 510 of FIG. 6) configured to transmit and receive a wireless signal to and from a nearby device (e.g., the electronic device 102 of FIG. 1 or the electronic device 104 of FIG. 1) positioned around the electronic device. The electronic device may include at least one processor (e.g., the processor 120 of FIG. 1, the processor 203 of FIG. 2, or the processor 520 of FIG. 6) operatively connected to the wireless communication module. The electronic device may include memory (e.g., the memory 130 of FIG. 1, the memory 207 of FIG. 2, or the memory 530 of FIG. 6) storing instructions. The instructions may be executed by the processor individually or collectively to cause the electronic device to receive, from a user, an utterance for controlling the electronic device or the nearby device. The instructions may be executed by the processor individually or collectively to cause the electronic device to obtain information utilized for machine reading comprehension based on an analysis result of the utterance. The instructions may be executed by the processor individually or collectively to cause the electronic device to obtain additional information related to the utterance by performing machine reading comprehension based on the information. The instructions may be executed by the processor individually or collectively to cause the electronic device to provide the user with a response corresponding to the utterance based on the additional information.

According to an embodiment, the instructions may be executed by the processor individually or collectively to cause the electronic device to obtain information utilized for the machine reading comprehension when the utterance includes an unsupported control command, when the utterance includes an unsupported parameter value, or when the utterance includes a parameter preset to provide the additional information.

According to an embodiment, the information utilized for the machine reading comprehension may include at least one of information on the electronic device, information on the nearby device, a query for crawling data, crawled data, or a question for obtaining a machine reading comprehension result.

According to an embodiment, the instructions may be executed by the processor individually or collectively to cause the electronic device to obtain the information on the electronic device or the information on the nearby device based on the analysis result of the utterance. The instructions may be executed by the processor individually or collectively to cause the electronic device to generate a query for crawling data based on the information on the electronic device or the information on the nearby device. The instructions may be executed by the processor individually or collectively to cause the electronic device to crawl data based on the query. The instructions may be executed by the processor individually or collectively to cause the electronic device to generate a question for performing machine reading comprehension on the crawled data.

According to an embodiment, the instructions may be executed by the processor individually or collectively to cause the electronic device to obtain the additional information by performing machine reading comprehension on the crawled data based on the question.

According to an embodiment, the additional information may include information related to a control action included in the utterance.

According to an embodiment, according to the utterance, the additional information may include a reason for which the electronic device or the nearby device is unable to be controlled.

According to an embodiment, the additional information may include guidance for correcting the control action included in the utterance.

An electronic device (e.g., the electronic device 101 of FIG. 1, the electronic device 201 of FIG. 2, or the electronic device 501 of FIG. 5) according to an embodiment may include at least one wireless communication module (e.g., the wireless communication module 192 of FIG. 1 or the wireless communication module 510 of FIG. 6) configured to transmit and receive a wireless signal to and from a nearby device (e.g., the electronic device 102 of FIG. 1 or the electronic device 104 of FIG. 1) positioned around the electronic device. The electronic device may include at least one processor (e.g., the processor 120 of FIG. 1, the processor 203 of FIG. 2, or the processor 520 of FIG. 6) operatively connected to the wireless communication module. The electronic device may include memory (e.g., the memory 130 of FIG. 1, the memory 207 of FIG. 2, or the memory 530 of FIG. 6) storing instructions. The instructions may be executed by the processor individually or collectively to cause the electronic device to receive, from a user, an utterance for controlling the electronic device or the nearby device. The instructions may be executed by the processor individually or collectively to cause the electronic device to generate a question based on an analysis results of the utterance. The instructions may be executed by the processor individually or collectively to cause the electronic device to, based on the question, provide the user with a response including the additional information related to the utterance. The question may be utilized for machine reading comprehension.

According to an embodiment, the instructions are executed by the processor individually or collectively to cause the electronic device to generate the question when the utterance includes an unsupported control command, when the utterance includes an unsupported parameter value, or when the utterance includes a parameter preset to provide the additional information.

According to an embodiment, the instructions may be executed by the processor individually or collectively to cause the electronic device to obtain the information on the electronic device or the information on the nearby device based on the analysis result of the utterance. The instructions may be executed by the processor individually or collectively to cause the electronic device to generate a query for crawling data based on the information on the electronic device or the information on the nearby device. The instructions may be executed by the processor individually or collectively to cause the electronic device to crawl data based on the query. The instructions may be executed by the processor individually or collectively to cause the electronic device to generate the question for performing machine reading comprehension on the crawled data.

According to an embodiment, the instructions may be executed by the processor individually or collectively to cause the electronic device to obtain the additional information by performing machine reading comprehension on the crawled data based on the question. The instructions may be executed by the processor individually or collectively to cause the electronic device to provide the user with a response based on the additional information.

According to an embodiment, the additional information may include information related to a control action included in the utterance.

According to an embodiment, according to the utterance, the additional information may include a reason for which the electronic device or the nearby device is unable to be controlled.

According to an embodiment, the additional information may include guidance for correcting the control action included in the utterance.

A method of operating an electronic device (e.g., the electronic device 101 of FIG. 1, the electronic device 201 of FIG. 2, or the electronic device 501 of FIG. 5) according to an embodiment may include an operation of receiving, from a user, an utterance for controlling the electronic device or a nearby device. Based on the analysis result of the utterance, the method may include an operation of obtaining information utilized for machine reading comprehension. The method may include an operation of obtaining additional information related to the utterance by performing machine reading comprehension based on the information. Based on the additional information, the method may include an operation of providing the user with a response corresponding to the utterance.

According to an embodiment, the operation of obtaining the information utilized for the machine reading comprehension may be performed when the utterance includes an unsupported control command, when the utterance includes an unsupported parameter value, or when the utterance includes a parameter preset to provide the additional information.

According to an embodiment, the information utilized for the machine reading comprehension may include at least one of information on the electronic device, information on the nearby device, a query for crawling data, crawled data, or a question for obtaining a machine reading comprehension result.

According to an embodiment, the operation of obtaining the information utilized for the machine reading comprehension may include, based on an analysis result of the utterance, an operation of obtaining information on the electronic device or information on the nearby device. The operation of obtaining the information utilized for the machine reading comprehension may include, based on the information on the electronic device or the information on the nearby device, an operation of generating a query for crawling data. The operation of obtaining the information utilized for the machine reading comprehension may include, based on the query, an operation of crawling data. The operation of obtaining the information utilized for the machine reading comprehension may include an operation of generating a question for performing machine reading comprehension for the crawled data.

According to an embodiment, the operation of obtaining the additional information may include, based on the question, an operation of obtaining the additional information by performing machine reading comprehension on the crawled data.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the present disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st” and “2nd,” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the present disclosure, the term “module” may include a unit implemented in hardware, software, or firmware and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., a program 1740) including one or more instructions that are stored in a storage medium (e.g., internal memory 1736 or external memory 1738) that is readable by a machine (e.g., an electronic device 1701). For example, a processor (e.g., a processor 1720) of the machine (e.g., the electronic device 1701) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where the data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one wireless communication circuit configured to transmit and receive a wireless signal to and from a nearby device positioned around the electronic device;
at least one processor operatively connected to the at least one wireless communication circuit; and
memory storing instructions,
wherein the instructions, when executed by the at least one processor individually or collectively, cause the electronic device to:
receive, from a user, an utterance for controlling the electronic device or the nearby device;
based on an analysis result of the utterance, obtain information utilized for machine reading comprehension;
obtain additional information related to the utterance by performing the machine reading comprehension based on the information; and
based on the additional information, provide the user with a response corresponding to the utterance.

2. The electronic device of claim 1, wherein the information utilized for the machine reading comprehension is obtained when the utterance comprises at least one of:
an unsupported control command;
an unsupported parameter value; and
a parameter preset to provide the additional information.

3. The electronic device of claim 1, wherein the information utilized for the machine reading comprehension comprises at least one of information about the electronic device, information about the nearby device, a query for crawling data, crawled data, or a question for obtaining a machine reading comprehension result.

4. The electronic device of claim 1, wherein
the instructions, when executed by the at least one processor individually or collectively, cause the electronic device to: based on the analysis result of the utterance, obtain the information on the electronic device or the information on the nearby device;
based on the analysis result of the utterance, obtain the information on the electronic device or the information on the nearby device;
based on the information on the electronic device or the information on the nearby device, generate a query for crawling data;
crawl data based on the query; and
generate a question for performing machine reading comprehension on the crawled data.

5. The electronic device of claim 4, wherein the additional information is obtained by performing the machine reading comprehension on the crawled data based on the question.

6. The electronic device of claim 1, wherein the additional information comprises information related to a control action comprised in the utterance.

7. The electronic device of claim 1, wherein according to the utterance, the additional information comprises a reason for which the electronic device or the nearby device is unable to be controlled.

8. The electronic device of claim 1, wherein the additional information comprises guidance for correcting a control action comprised in the utterance.

9. An electronic device comprising:
at least one wireless communication circuit configured to transmit and receive a wireless signal to and from a nearby device positioned around the electronic device;
at least one processor operatively connected to the at least one wireless communication circuit; and
memory storing instructions,
wherein the instructions, when executed by the at least one processor individually or collectively, cause the electronic device to:
receive, from a user, an utterance for controlling the electronic device or the nearby device;
based on an analysis result of the utterance, generate a question; and
based on the question, provide the user with a response comprising additional information related to the utterance, and
wherein the question is utilized for machine reading comprehension.

10. The electronic device of claim 9, wherein the question is generated when the utterance comprises at least one of:
an unsupported control command;
an unsupported parameter value; and
a parameter preset to provide the additional information.

11. The electronic device of claim 9, wherein the instructions, when executed by the at least one processor individually or collectively, cause the electronic device to:
based on the analysis result of the utterance, obtain information about the electronic device or information about the nearby device;
based on the information about the electronic device or the information about the nearby device, generate a query for crawling data;
crawl data based on the query; and
generate the question for performing the machine reading comprehension on the crawled data.

12. The electronic device claim 11, wherein the instructions, when executed by the processor individually or collectively, cause the electronic device to:
based on the question, obtain the additional information by performing machine reading comprehension on the crawled data; and
based on the additional information, provide the user with the response.

13. The electronic device claim 9, wherein the additional information comprises information related to a control action comprised in the utterance.

14. The electronic device of claim 9, wherein according to the utterance, the additional information comprises a reason for which the electronic device or the nearby device is unable to be controlled.

15. The electronic device of claim 9, wherein the additional information comprises guidance for correcting a control action comprised in the utterance.

16. A method of operating an electronic device comprising:
receiving, from a user, an utterance for controlling the electronic device or a nearby device;
based on an analysis result of the utterance, obtaining information utilized for machine reading comprehension;
obtaining additional information related to the utterance by performing the machine reading comprehension based on the information; and
based on the obtaining the additional information, providing the user with a response corresponding to the utterance.

17. The method of claim 16, wherein the information utilized for the machine reading comprehension is obtained when the utterance comprises at least one of:
an unsupported control command;
an unsupported parameter value; and
a parameter preset to provide the additional information.

18. The method of claim 16, wherein the information utilized for the machine reading comprehension comprises at least one of information about the electronic device, information about the nearby device, a query for crawling data, crawled data, or a question for obtaining a machine reading comprehension result.

19. The method of claim 16, further comprising
based on the information being obtained, generate a query for crawling data;
crawl data based on the query; and
generate a question for performing the machine reading comprehension on the crawled data,
wherein the information utilized for the machine reading comprehension is about the electronic device or the nearby device.

20. The method of claim 19, wherein the additional information is obtained by performing the machine reading comprehension on the crawled data based on the question.
